(19) United States
(12) Patent Application Publication
(10) Pub. No.: US 2011/0153828 A1
(43) Pub. Date: Jun. 23, 2011

(54) LOAD BALANCING APPARATUS AND METHOD FOR REGULATING LOAD USING THE SAME

(75) Inventors: Hong-Shik PARK, Daejeon (KR); Young Tae Han, Gyeonggi-do (KR)

(73) Assignee: KOREA ADVANCED INSTITUTE OF SCIENCE AND TECHNOLOGY, Daejeon (KR)

(21) Appl. No.: 12/956,252

(22) Filed: Nov. 30, 2010

(30) Foreign Application Priority Data
Dec. 17, 2009 (KR) 10-2009-0125819
Aug. 23, 2010 (KR) 10-2010-0081600

(51) Int. Cl. G06F 15/173

(52) U.S. Cl. 709/226

(57) ABSTRACT

An apparatus for load balancing multiple servers on a network includes: a delay calculation unit for calculating a server-side delay for each server by using network transmission delay, network waiting delay, and operation processing delay of each of the servers; and a load regulating unit for regulating loads to be assigned to each server based on the server-side delay for each server calculated by the delay calculation unit. The apparatus of further includes a status detection unit for monitoring a change in the server-side delay of each server to determine the status of each server.

### FIELD OF THE INVENTION

The present invention relates to load balancing of network servers for processing connection requests, and more particularly, to a load balancing apparatus, which detects status of servers and evenly processes the connection requests based on the detected status, and a method for regulating loads of the servers.

### BACKGROUND OF THE INVENTION

A conventional load balancing method, such as round robin, focuses only on network or server load. Thus, load balancing is performed regardless of server status or by assigning a different weight to each server. For example, in the conventional load balancing method, when requests for the same content from the different clients to a server farm which is a collection of computer servers, the requests for the same content are assigned to a server with the least loads. Such assignment is made on the basis of the amount of loads without considering extra burdens of the server. The least load requirement does not guarantee the server can afford to process the client requests because each server in the server farm may perform various operations, e.g., backup operations, as well as processing the client requests. Thus, when such backup operations are performed, the server may not enough to process the client requests even if the load status of the server is good.

Therefore, the conventional load balancing method has the problem in that a request from a client cannot be properly processed even under the least load of the server because the request is assigned to the server based on the load of the server regardless of the extra burdens.

To overcome this problem, there has been proposed a method for detecting the status of a server through the user of an active measurement to perform the analysis of a processing time of the server on a request from a client and a traffic generated between the server and the client. However, this method may cause additional traffic and also deteriorate the performance of the server.

### SUMMARY OF THE INVENTION

Therefore, the present invention provides a load balancing apparatus capable of balancing network performances between clients by detecting a status of a server using network transmission delay, network waiting delay, and server-side operation processing delay to process client requests from clients based on the detected status, and a method for regulating load on the server by using the same.

In accordance with an aspect of the present invention, there is provided an apparatus for load balancing multiple servers on a network including: a delay calculation unit for calculating a server-side delay for each server by using network transmission delay, network waiting delay, and operation processing delay of each of the servers; and a load regulating unit for regulating loads to be assigned to each server based on the server-side delay for each server calculated by the delay calculation unit.

In accordance with another aspect of the present invention, there is provided an apparatus for load balancing multiple servers on a network including: a delay calculation unit for calculating a server-side delay for each server by using network transmission delay, network waiting delay, and operation processing delay of each server; and a load regulating unit for uniformly distributing connection requests from the clients to the servers, calculating a delay rate of each server by using the sum of the server-side delay and the server-side delay of each server, calculating a DC of each server by using the calculated delay rate of each server, and regulating a load assigned to each server based on the calculated DC of each server.

In accordance with still another aspect of the present invention, there is provided a method for regulating loads on a communication network, the method including: initializing deficit counters (DCs) for the servers in an initial state; uniformly distributing connection requests from clients to the servers; calculating server-side delay for each server by using network transmission delay, network waiting delay, and operation processing delay of each server; calculating a delay rate of each server by using the sum of the server-side delay for the respective servers and the server-side delay of each server; calculating the DCs for the servers by using the calculated delay rates of the servers, respectively; and regulating loads assigned to the server based on the calculated DCs of the servers, respectively.

### BRIEF DESCRIPTION OF THE DRAWINGS

The above and other objects and features of the present invention will become apparent from the following description of embodiments, given in conjunction with the accompanying drawings, in which:

FIG. 1 is a block diagram showing a load balancing apparatus in accordance with an embodiment of the present invention;

FIG. 2 is a flowchart showing a process in which the load balancing apparatus shown in FIG. 1 measures a server side delay and then regulates the load assigned to the server; and

FIG. 3 is a view showing a network configuration including the load balancing apparatus shown in FIG. 1.

### DETAILED DESCRIPTION OF THE EMBODIMENT

Hereinafter, the embodiment of the present invention will be described in detail with reference to the accompanying drawings which form a part hereof.

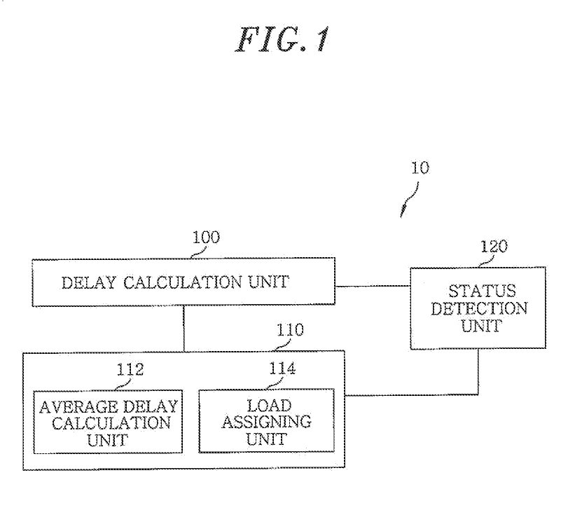

FIG. 1 is a block diagram showing a load balancing apparatus 10 in accordance with an embodiment of the present invention.

Referring to FIG. 1, the load balancing apparatus 10 includes a delay calculation unit 100, a load regulating unit 110 and a status detection unit 120.

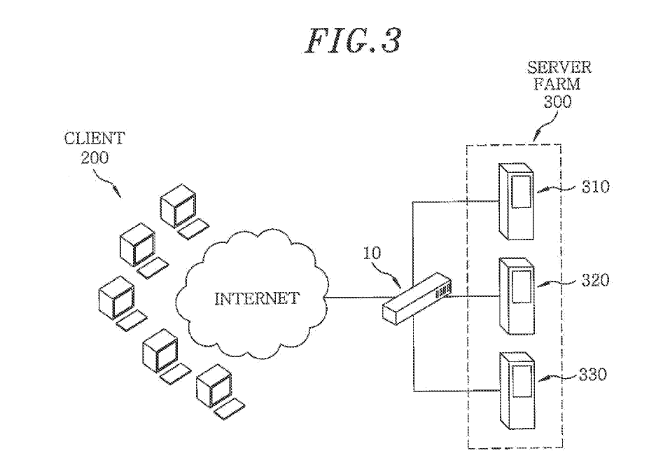

This load balancing apparatus 10 is located between clients 200 and a server farm 300 having a first server 310, a second server 320 and a j-th server 330 as shown in FIG. 3 and measures a delay on a server at an Internet connection, e.g., transmission control protocol (TCP) connection. That is, the load balancing apparatus 10 is installed on a communication network 350, e.g., the internet, for connecting the clients 200 and the servers 310 to 330 to measure a delay at each server.

For establishing a TCP connection, TCP flags are used. Examples of the TCP flags include SYN, DATA, ACK, FIN and the like. Three-way handshaking SYN-SYN/ACK-ACK is used for communication between a server and a client, DATA-ACK is used for data transmission, and FIN-FIN/ACK-ACK is used for terminating the TCP connection.

In the embodiment of the present invention, in delay measurement, SYN-SYN/ACK-ACK is defined as a minimum delay.

Further, the types of delay in the data transmission may include network transmission delay, network waiting delay, server-side operation processing delay, and client-side operation processing delay.

From the point of view of the load balancing apparatus between a server and a client, the delay is classified into server-side delay and client-side delay. The server-side delay includes network transmission delay D_{P}^{S} from the load balancing apparatus to a server, network waiting delay D_{Q}^{S}, and server-side operation processing delay D_{C}^{S;} and the client-side delay includes a network transmission delay D_{P}^{C} from the load balancing apparatus to the client, network waiting delay D_{Q}^{C}, and client operation processing delay D_{C}^{C}.

In the load balancing apparatus in accordance with the embodiment of the present invention, the delay calculation unit 100 calculates a server-side two-way delay for the servers. That is, a server-side delay value Dₚ(j) for the servers 310 to 330 can be calculated by adding the network transmission delay D_{P}^{S} from the load balancing apparatus to the j-th server, the network waiting delay D_{Q}^{S}, and the server side operation processing delay D_{C}^{S} observed by the j-th server, as expressed in the following Eq. 1:

D_{P}(j)=2D_{P}^{S}(j)+2D_{Q}^{S}(j)+D_{C}^{S} Eq. 1

The delay calculation unit 100 calculates a server-side delay for each of the servers connected to the load balancing apparatus by using the above Eq. 1 to provide the calculated server-side delay for each server to both the load regulating unit 110 and the status detection unit 120.

In this embodiment, the server-side delay for each server is calculated on the assumption that the path and capacity of each server are fixed and are calculated. The delay calculation unit 100 calculates the server-side delay for each server at predetermined time intervals, and provides the load regulating unit 110 with the server-side delay value for each server calculated at the predetermined time intervals.

The load regulating unit 110 regulates the load assigned to each of the servers based on the server-side delay for each server. This load regulating unit 110 includes an average delay calculation unit 112 and a load assigning unit 114. The average delay calculation unit 112 receives the server-side delays from the delay calculation unit 100 and calculates an average delay of the servers by using the received server-side delays for a preset period of time and the number of the observed server-side delays. The load assigning unit 114 assigns a connection request or a load to each of the servers using the average delay calculated by the average delay calculation unit 112.

Further, the load regulating unit 110, in an initial state, initializes a deficit counter (hereinafter, referred to as “DC”) for each server and then uniformly distributes the connection requests or the loads of the connection requests from the clients to the servers. Thereafter, the load regulating unit 110 calculates a delay rate of each server by using the sum of the server-side delays calculated by the delay calculation unit 100 and the server-side delay of each server.

The load regulating unit 110 then calculates the DC of each server by using the calculated delay rate of each server, and regulates the load assigned to each server based on the calculated DC of each server. That is, the amount of the load assigned to each sever is determined in proportion to the value of DC of the server.

The status detection unit 120 checks the status of each server while monitoring changes in the server-side delay of each server. That is, when the server-side delay for a server increases, it is determined that the status of the corresponding server becomes worse than the previous status, and when the server-side delay decreases, it is determined that the status of the corresponding server becomes better than the previous status.

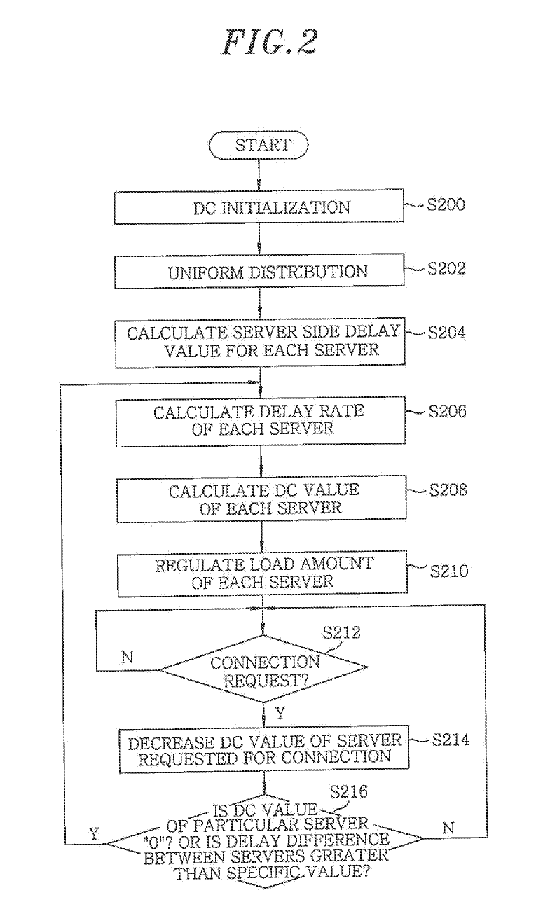

FIG. 2 is a flowchart showing a process in which the load balancing apparatus in accordance with the embodiment of the present invention measures a server-side delay for each server and then regulates the load assigned to each server based on the calculated sever-side delay.

First, as shown in FIG. 2, the load balancing apparatus, in an initial state, initializes the DCs for all servers, e.g., servers 310, 320 and 330 shown in FIG. 3 in step S200. In other words, the load balancing apparatus sets the DCs for all servers to “0”.

Next, the load balancing apparatus uniformly distributes connection requests of the clients 200 to the servers 310, 320, and 330 in step S202.

Thereafter, in step S204, the delay calculation unit 102 measures network transmission delay, network waiting delay, and operation processing delay, and then calculates a server-side delay for the j-th server by using the above Eq. 1. In this manner, all the server-side delays for the first to j-th servers 310 to 330 are calculated.

The server-side delays for the servers 310, 320 and 330 are measured during the status of TCP flags DATA-ACK for data transmission. The server-side delays for the servers 310, 320 and 330 are provided to the load regulating unit 110.

Then, the load regulating unit 110 calculates the delay rates of the respective servers by using the server-side delays of the servers 310, 320 and 330 and the sum thereof in step S206. In other words, the delay rate of the server 310 is calculated by a ratio of the sum of the server-side delays of the servers to the server-side delay of the server 310; the delay rate of the server 320 is calculated by a ratio of the sum of the server-side delay values of the servers and the server-side delay value of the server 320; and the delay rate of the server 330 is calculated by a ratio of the sum of the server-side delay values of the servers and the server-side delay value of the server 330. Next, the load regulating unit 110 calculates the DCs by using the calculated delay rates.

Thereafter, the load regulating unit 110 regulates the loads to the servers by using the calculated DCs in step S210. To be more specific, the loads to be processed by the servers amount to the calculated DCs of the servers A, B, and C, and then the connection requests are assigned to the servers 310, 320 and 330 based on the amounts of loads.

In step S212, it is checked that there is a connection request to the servers.

The load regulating unit 110 decreases the DC by a predetermined value, e.g., “1” each time the connection request is made to the respective servers in step S214, respectively, and determines whether any one of the DCs of the respective servers becomes “0” or a delay difference between the servers is greater than a specific threshold in step S216.

As a result of the determination of step S216, when any one of the DCs of the servers becomes “0” or a delay difference between the servers is greater than the specific threshold, the process returns to step S206 to re-calculates the DCs of the respective servers. Moreover, if not, the process returns to step S212 to check the connection request.

In accordance with the embodiment of the present invention, the status of a server is detected using network transmission delay, network waiting delay, and server-side operation processing delay when processing connection requests from clients, and then the client request is processed based on the detected status of the server, thus ensuring a balancing of network performance between the clients.

While the invention has been shown and described with respect to the particular embodiments, it will be understood by those skilled in the art that various changes and modification may be made without departing from the scope of the invention as defined in the following claims.

What is claimed is:

1. An apparatus for load balancing multiple servers on a network, comprising:
a delay calculation unit for calculating a server-side delay for each server by using network transmission delay, network waiting delay, and operation processing delay of each of the servers; and
a load regulating unit for regulating loads to be assigned to each server based on the server-side delay for each server calculated by the delay calculation unit.

2. The apparatus of claim 1, further comprising a status detection unit for monitoring a change in the server-side delay of each server to determine the status of each server.

3. The apparatus of claim 1, wherein the server-side delay of each server is calculated at predetermined time intervals.

4. The apparatus of claim 3, wherein the load regulating unit includes:
an average delay calculation unit for calculating an average delay of each server by dividing the server-side delays of the servers by the number of the server-side delay; and
a load assigning unit for assigning the loads to the servers by using the average delays in response to connection requests from the clients to the servers by using the average delays.

5. An apparatus for load balancing multiple servers on a network, comprising:
a delay calculation unit for calculating a server-side delay for each server by using network transmission delay, network waiting delay, and operation processing delay of each server; and
a load regulating unit for uniformly distributing connection requests from the clients to the servers, calculating a delay rate of each server by using the sum of the server-side delay and the server-side delay of each server, calculating a DC of each server by using the calculated delay rate of each server, and regulating a load assigned to each server based on the calculated DC of each server.

6. The apparatus of claim 5, wherein, when a connection request is made to a server, the load regulating unit decreases the DC of the corresponding server by a predetermined value.

7. The load balancing apparatus of claim 6, wherein, the server-side delay for each server is re-calculated when the DC of any one of the servers becomes “0” or a delay difference between the servers is greater than a predetermined threshold value.

8. A method for regulating loads on a communication network, the method comprising:
initializing deficit counters (DCs) for the servers in an initial state;
uniformly distributing connection requests from clients to the servers;
calculating server-side delay for each server by using network transmission delay, network waiting delay, and operation processing delay of each server;
calculating a delay rate of each server by using the sum of the server-side delay for the respective servers and the server-side delay of each server;
calculating the DCs for the servers by using the calculated delay rates of the servers, respectively; and
regulating loads assigned to the server based on the calculated DCs of the servers, respectively.

9. The method of claim 8, further comprising, when a connection request is made to a server, decreasing the DC of the corresponding server by a predetermined value.

10. The method of claim 8, wherein, when any one of the DCs of the servers becomes “0” or a delay difference between the servers is greater than a predetermined threshold, the server-side delays for the server are re-calculated.
